(19) United States
(12) Patent Application Publication
(10) Pub. No.: US 2015/0279223 A1
(43) Pub. Date: Oct. 1, 2015

(54) SYSTEMS AND METHODS FOR PROVIDING EMOTIONALLY POSITIVE CONTENT TO MOTIVATE COMPLIANCE WITH MEDICAL TREATMENT REGIMENS

(71) Applicant: Charles L. Coltman, IV, Philadelphia, PA (US)

(72) Inventor: Charles L. Coltman, IV, Philadelphia, PA (US)

(21) Appl. No.: 14/228,011

(22) Filed: Mar. 27, 2014

(51) Int. Cl. G09B 5/02

(52) U.S. Cl. CPC G09B 5/02

(57) ABSTRACT

Emotionally positive content may be provided to motivate compliance with medical treatment regimens. A user may be provided with a schedule including (1) tasks associated with a medical treatment regimen of the user and (2) indications of when individual ones of the tasks are to be performed by the user. A concealed (or hidden) rendering of a unit of content (e.g., still image or video) may be provided for presentation to the user. The unit may be progressively revealed by removing portions of an overlay. The removal of individual ones of the portions may be associated with performance of corresponding tasks. The portions may be removed until the unit of content is completely revealed responsive to a set of the tasks being performed by the user. The unit may be designed to stimulate a dopamine response in the brain of the user when the unit is observed by the user

### FIELD OF THE DISCLOSURE

This disclosure relates to systems and method for providing emotionally positive content to motivate compliance with medical treatment regimens.

### BACKGROUND

Medical adherence or the process of a patient following their treatment plans may present serious problems in healthcare. Most commonly, medical adherence may refer to medication or drug compliance, but it can also apply to other situations such as medical device use, self-care self-directed exercises, or therapy sessions. Both the patient and the healthcare provider may affect compliance. A positive physician-patient relationship may be an important factor in improving compliance, although the high cost of prescription medication may also play a major role. Worldwide, non-compliance is a major obstacle to the effective delivery of health care. Estimates from the World Health Organization indicate that only about 50% of patients with chronic diseases living in developed countries follow treatment recommendations. In particular, low rates of adherence to therapies for diabetes, asthma, cancer, and hypertension are thought to contribute substantially to the human and economic burden of those conditions. Compliance rates may be overestimated in the medical literature, as compliance is often high in the setting of a formal clinical trial but drops off in a “real-world” setting.

Major barriers to compliance are thought to include the complexity of modern medication regimens, poor “health literacy” and lack of comprehension of treatment benefits, the occurrence of undisguised side effects, the cost of prescription medicine, and poor communication or lack of trust between the patient and his or her healthcare provider. Efforts to improve compliance have been aimed at simplifying medication packaging, providing effective medication reminders, improving patient education, and limiting the number of medications prescribed simultaneously. Poor compliance can lead to significant cost to a country's health system. It is estimated that, in the United States, $450 Billion of cost may due to medical adherence and medication issues.

### SUMMARY

One aspect of the disclosure relates to a system configured for providing emotionally positive content to motivate compliance with medical treatment regimens. Exemplary implementations may include a software application that simulates a visual game or puzzle that needs to be solved by the user to receive a visual reward. The puzzle pieces may represent a series of actions or behaviors that a person with a medical condition is recommended by his or her physician that will help alleviate, minimize, or even manage the conditions that impact the body so as not to allow the medical condition to get worse. This could be in the form of consuming the right foods, taking their medications each day, getting the right amount of exercise, monitoring ones weight, or following other courses of action required in their treatment plan. Exemplary implementations may be designed for the organization and scheduling of the taking of a user's medications during the day, as this represents a common problem. Some implementations include the actions and or behaviors of a patient's medical treatment plan. When the user achieves all of the pieces to the puzzle, the visual image may be revealed to the user as a reward. The visual reward could be any emotionally positive stimulating image such as erotic, humorous jokes, or any inspirational quote or image that produces a dopamine response in the brain.

In some implementations, the system may include one or more servers. The server(s) may be configured to communicate with one or more client computing platforms according to a client/server architecture. The users may access the system via the client computing platform(s).

The server(s) may be configured to execute computer program instructions. The computer program instructions may include one or more of a user component, a relationship component, a task scheduler component, a content component, a gamification component, a socialization component, a virtual currency component, and/or other components. The user component may be configured to access and/or manage one or more user profiles and/or user information associated with users of the system. The relationship component may be configured to establish, acknowledge, identify, and/or otherwise manage relationships between users of the system.

The task scheduler component may be configured to provide a schedule to a user. The schedule may include (1) tasks associated with a medical treatment regimen of the user and (2) indications of when individual ones of the tasks are to be performed by the user. The schedule may be based on input received from a healthcare provider. Examples of a healthcare provider may include one or more of a doctor, a nurse, a nurse practitioner, a physical therapist, a pharmacist, a family member, and/or other individuals that provide care. A given healthcare provider may be a professionally trained individual or an untrained individual. The schedule may be received from one or both of the user and/or a healthcare provider associated with the user. In some implementations, the user and/or a healthcare provider may access the schedule and provide revisions to the schedule. Such revisions may require approval by the user and/or a healthcare provider prior to being incorporated into the schedule, according to some implementations. The schedule may be prescribed by a healthcare provider. In some implementations, the task scheduler component may be configured to receive input from a healthcare provider and/or enable a healthcare provider to manipulate the schedule.

A given task may include an action associated with healthcare that is performed by the user. Examples of tasks may include one or more of taking a medication, performing a physical activity, monitoring weight, performing exercises, performing physical therapy such as for rehabilitation purposes, consuming a specific diet, using a medical device correctly, performing other actions that help address a specific health condition, performing other actions that help address side effects from certain medications, taking a reading from a medical device that is integrated with a client computing platform associated with the user, taking a reading from a medical device that is communicatively coupled with a client computing platform associated with the user, having a reading form a medical device be in a specific range, and/or other tasks.

In some implementations, task scheduler component may be configured to provide an alarm to the user to prompt the user to perform a given task. Such an alarm may include one or more of an audible sound, haptic feedback (e.g., a physical vibration), a visual indication, a pre-recorded message sent through a phone call to the user, and/or other alarms. In some implementations, such a pre-recorded message may include a voice message from a loved one of the user, a friend of the user, a healthcare provider, and/or other individuals.

The task scheduler component may be configured to receive an indication from a user that one or more of the tasks have been performed or completed. In some implementations, the user may provide input via a client computing platform to indicate a given task has been completed. For example, via a graphical user interface of a client computing platform, the user may check a box, click an icon, swipe an item, tap a portion of an image, and/or perform other methods for provided indications that individual tasks have been performed. In some implementations, an indication that one or more of the tasks have been performed or completed may be received automatically by the task scheduler component. For example, a client computing platform associated with the user and/or the server may be communicatively coupled to a medical device and/or therapeutic device configured to provide an indication that a task has been performed. Examples of a medical device and/or therapeutic device may include one or more of a heart monitor, a blood oxygen reader, a diabetic blood sugar reader, an activity tracker, a lung capacity reader (e.g., a spiroscope), and/or other medical devices and/or therapeutic devices. In some implementations, a client computing platform associated with the user may be integrated as a singular device with one or more medical devices and/or therapeutic devices. In some implementations, the task scheduler component may be configured to provide an indication to a healthcare provider and/or other entity that one or more tasks have been performed by the user.

The content component may be configured to provide emotionally positive units of content. A given unit may include one or more of a still image, a video, text (e.g., words used for motivation, humor, erotic poetry, and/or other text), and/or other content that can be observed by the user. A given unit of content may be designed to stimulate a dopamine response in the brain of the user when the first unit is observed by the user. In some implementations, a given unit of content may include explicit content portraying or suggesting sexual organs or sexual activity. A given unit of content may be erotic in nature. A given unit of content may be designed to stimulate erotic feelings. A given unit of content may be designed to stimulate aesthetic or emotional feelings.

The gamification component may be configured to add a game aspect to the system such that the user must perform certain tasks before the user can observe content provided by the content component. In some implementations, the gamification component may be configured to provide a given unit of content for presentation to the user via a client computing platform, wherein the given unit is initially presented as a concealed rendering of the given unit. The given unit may be associated with a given set of the tasks. In some implementations, the concealed rendering may depict the given unit as being obscured by an overlay or otherwise hidden. Such an overlay may be one or more of opaque, translucent, blurred, and/or formats that obscure underlying content. The gamification component may be configured to progressively reveal the given unit by removing portions of the overlay. The removal of individual ones of the portions may be associated with performance of corresponding tasks. By way of non-limiting example, if the user takes a medication at a scheduled time, then a portion of the overlay may be removed to reveal an underlying portion of the given unit of content, in accordance with some implementations. The portions may be removed until the given unit of content is completely revealed responsive to the given set of the tasks being performed by the user. In some implementations, the gamification component may be configured to disallow portions from being removed before corresponding tasks are due to be performed, according to a schedule provided by the task scheduler component.

The socialization component may be configured to facilitate interactions among users of the system. Such interactions may include one or more of text communications, voice communications, video communications, and/or other types of communications. The interactions may be among user patients their healthcare providers. The interactions may be among patient users of the system. The interactions include games associated with completing scheduled tasks. In some implementations, removed portions may be used to provide a message to another user wherein individual removed portions correspond to individual letters or words. The user may be able to “follow” (e.g., akin to Twitter® followers), connect with (e.g., akin to Facebook® friends), and/or otherwise be associated with other users of the system. Such an association may be established responsive to a request from a first user to a second user. In some implementations, the second user may be required to approve the request.

In some implementations, the socialization component may facilitate a unit of content may be provided and/or created by other users of the system. Those other users may also be associated with the user (e.g., the other users may follow the user, the user may follow the other users, the user may be connected with the other users, and/or other associations). According to some implementations, the socialization component may provide for presentation to the user a list of other users of the system and their respective profiles. By way of non-limiting example, the user may be able to follow individual ones of those users by clicking a follow button on a given other user's profile. The user may upload a picture (e.g., a self-portrait), which may be included in the user's profile. The socialization component may be configured to provide a notification to one or more other users associated with the user (e.g., followers, followees, connections, and/or other associated users). Such a notification may inform a given user that a hidden image (uploaded by the user) may be accessed and revealed, as described in connection with the gamification component. The approach may allow the user to receive content that meets his/her specific needs or tastes. For example, the user may want to “follow” their favorite baseball player, celebrity, or other figure depending on their tastes.

The virtual currency component may be configured to facilitate usage of virtual currency within the system. In some implementations, removed portions of the overlay may be used as or equated to a virtual currency. Exposed units of content may be used as or equated to a virtual currency. An amount of virtual currency may be provided to a user responsive to a threshold number of portions being removed. Virtual currency may be redeemed for certain content (e.g., rare images, previously locked content, content provided by third-party entities, and/or other content), certain privileges (e.g., revealing an addition portion of a unit of content to accelerate the entire unit being revealed, and/or other privileges), and/or other items or information. By way of non-limiting illustration, a partner company such as a pharmaceutical company may want to ask the user questions about aspects of a drug taken by the user (e.g., any side effects experienced by the user, medical issues that the user is having, and/or other aspects of the drug). In order to reward the user for answering such questions, the partner company may provide to the user virtual currency, additional content, privileges within the system, and/or other information or items to motivate the user to answer the questions.

These and other features, and characteristics of the present technology, as well as the methods of operation and functions of the related elements of structure and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the invention. As used in the specification and in the claims, the singular form of “a”, “an”, and “the” include plural referents unless the context clearly dictates otherwise.

### BRIEF DESCRIPTION OF THE DRAWINGS

FIG. 1 illustrates a system configured for providing emotionally positive content to motivate compliance with medical treatment regimens, in accordance with one or more implementations.

FIG. 2 illustrates an exemplary implementation of a unit of content that is partially revealed.

FIG. 3 illustrates an exemplary implementation in which the user earns puzzle pieces for completing all tasks associated with individual days of the week.

FIG. 4 illustrates a method for providing emotionally positive content to motivate compliance with medical treatment regimens, in accordance with one or more implementations.

### DETAILED DESCRIPTION

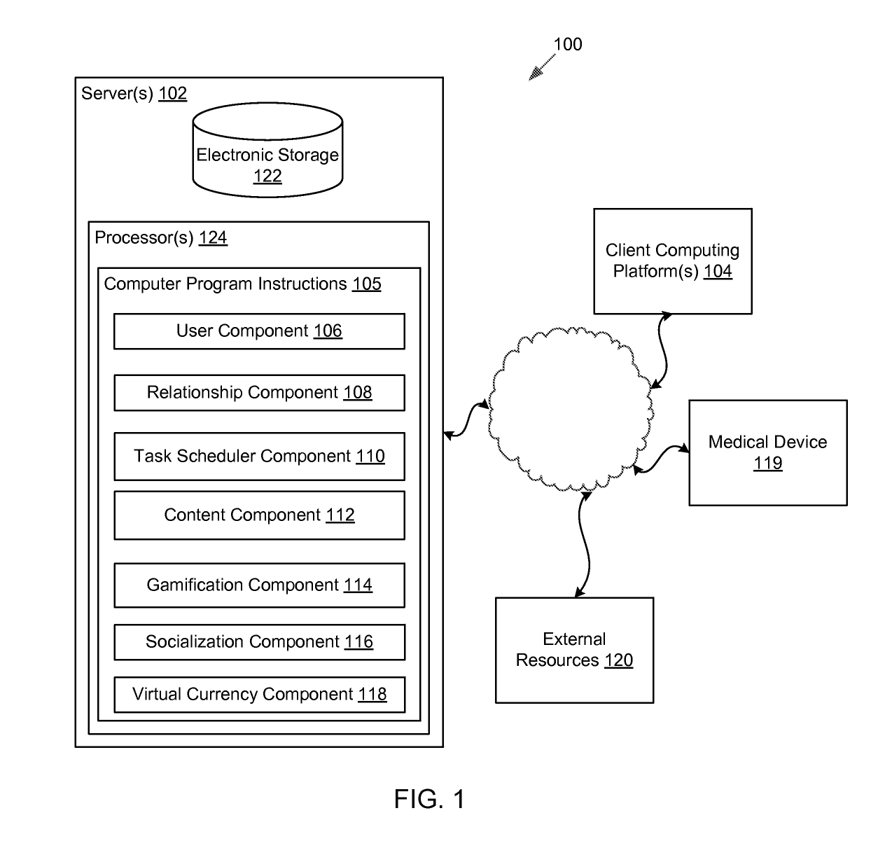

FIG. 1 illustrates a system 100 configured for providing emotionally positive content to motivate compliance with medical treatment regimens, in accordance with one or more implementations. One of the main reasons for poor compliance may relate to the complexity of human behavior. Patients may suffer from a number of problems when it comes to their health. Taking pills everyday produces no short-term physical and emotional benefit.

By way of non-limiting illustration, an analogy may entail using one's car like using one's body. Taking pills or getting the right amount of sleep, exercise, or eating correctly may be analogous, for illustrative purposes, to filling up your gas tank. Your body runs regardless of whether you take these medications or follow a treatment plan. Taking pills or following your treatment plans may be viewed like maintenance schedules for cars. It is general knowledge that a car should get its oil changed every 3000 miles. But many people forget or think “it is not that important” or “I have other things to do.” The car still runs and people say, “I'll do it another time.” There is no immediate punishment or immediate reward for this behavior. For example, a common problem in cancer care is that patients do not take their chemotherapy pills even when this is the only thing that is fighting the cancer. Many patients say the reason for this is that (1) they felt good that day, (2) they did not want to experience the side effects, or (3) taking chemotherapy is a reminder of the fact they have cancer and may die. Exemplary implementations use game mechanics and short-term visual reward systems to motivate patients to follow their treatment and medication plans by providing a visual and emotional stimulation rewards.

The behavioral approach system (BAS) from Gray's reinforcement sensitivity theory is a neurobehavioral system involved in the processing of rewarding stimuli that has been related to dopaminergic brain areas. Gray's theory hypothesizes that the functioning of reward brain areas is modulated by BAS-related traits. To test this hypothesis, a study was performed where participants viewed erotic and neutral pictures, and cues that predicted their appearance. Forty-five heterosexual men completed the Sensitivity to Reward scale (from the Sensitivity to Punishment and Sensitivity to Reward Questionnaire) to measure BAS-related traits. Results showed that Sensitivity to Reward scores correlated positively with brain activity during reactivity to erotic pictures in the left orbit frontal cortex, left insula, and right ventral striatum. These results demonstrated a relationship between the BAS and reward sensitivity during the processing of erotic stimuli, filling the gap of previous reports that identified the dopaminergic system as a neural substrate for the BAS during the processing of other rewarding stimuli such as money and food. In sum, results from scientific studies have been consistent in showing that reward sensitivity increases the response of reward brain areas during processing of both reward cues and reinforces such as money or appetizing foods, leaving an open gap for the processing of sex as a biological reward. Sexual behavior is one of the most important goal-directed behaviors essential for the survival of the animal species and is thought to engage brain mechanisms supporting reward processing. A key component of sexual behavior is sexual arousal, defined as physical and psychological readiness to perform sexual behavior. Sexual arousal may be initiated by external stimuli or may be produced by endogenous factors. Recent studies have used erotic stimuli to study brain areas involved in sexual arousal. These studies showed involvement of BAS-related areas such as the OFC, medial PFC, ACC, VS, and amygdala in sexual arousal.

Exemplary implementations aim to address medical adherence shortcomings by provide a scheduling and reminder tool for patients and/or their healthcare providers to set the patient medication or treatment plans on a daily schedule. When tasks are performed or completed (e.g., each medication or activity or activities during a specific day), users receive a visual reward. These rewards may use sexually arousing images, humorous images, and/or other emotionally positive images to stimulate biological positive reward systems in the brain to reinforce task-specific behaviors that involve a person's treatment, medications, and/or overall health. In exemplary implementations, a visual reward may be created through a jigsaw puzzle experience on a mobile device. As individual tasks are performed, a piece of the puzzle may be removed, earned, or a piece of the picture may be revealed either piece by piece or after the goals for the day are achieved. As the user achieves his or her goals of performing all scheduled tasks throughout the day, the picture may become progressively revealed or earned until the user's tasks are done and the reward is shown. In various behavioral studies, sexual arousal is the precursor to orgasm. One of the ways exemplary implementations attempt to recreate this experience with an anticipatory dopamine response as the game progresses, each piece of the image that is earned or revealed creates additional stimulus for the user and therefore creates a powerful motivator just like the process of sexual arousal to continue or to achieve the daily goals to reach the final visual reward.

Exemplary implementations may allow users to take their earned pieces throughout a period of time and use them in other gamified ways, such as a crossword puzzle or arrange these pieces in new ways to tell a story or receive an additional message or theme. These puzzle pieces may be used to arrange a message to another user. For example, a user may type in the message they want “revealed” to another user or third party (e.g., corporate sponsor) if they put a group of pieces in the right order on the screen. Clinical evidence suggests that stress reduction exercises such a meditation, yoga, and/or other behavior has a medical impact on the patient. In the case of cancer and hypertension, these stress reducing behaviors lower the inflammation responses in the brain. Exemplary implementations may reproduce these effects through dopamine reward triggers though humorous or erotic imagery.

In some implementations, system 100 may include one or more servers 102. The server(s) 102 may be configured to communicate with one or more client computing platforms 104 according to a client/server architecture. The users may access system 100 via client computing platform(s) 104.

The server(s) 102 may be configured to execute computer program instructions 105. The computer program instructions 105 may include one or more of a user component 106, a relationship component 108, a task scheduler component 110, a content component 112, a gamification component 114, a socialization component 116, a virtual currency component 118, and/or other components. One or more of components 106, 108, 110, 112, 114, 116, and/or 118 may be incorporated within and/or associated with an application programming Interface (API). Such an API may be configured to provide some or all functionalities of components 106, 108, 110, 112, 114, 116, and/or 118 to one or more aspects of system 100.

The user component 106 may be configured to access and/or manage one or more user profiles and/or user information associated with users of system 100. The one or more user profiles and/or user information may include information stored by server(s) 102, client computing platform(s) 104, and/or other storage locations. The user profiles may include, for example, information identifying users (e.g., a username, a number, an identifier, and/or other identifying information) within the system 100, security login information (e.g., a login code or password), account information, subscription information, virtual currency account information (e.g., related to currency held in credit for a user), relationship information (e.g., information related to relationships between users of system 100, system 100 usage information, demographic information associated with users, interaction history among users in system 100, information stated by users, purchase information of users, browsing history of users, a client computing platform identification associated with a user, a phone number associated with a user, and/or other information related to users.

The relationship component 108 may be configured to establish, acknowledge, identify, and/or otherwise manage relationships between users of system 100. Such relationships may include one or more of friendships, patient-healthcare provider relationships, familial relationships, guardianship relationships, connections, followers, and/or other relationships. The relationship component 108 may establish relationships based on relationship requests and acceptances received from users. Establishment of a relationship may be initiated by a single communication (e.g., a request) initiated by a given user requesting a relationship between the given user and one or more other users. Establishment of a relationship may require a first communication from the given user to be approved by the one or more other users. Relationships may include one or more types of relationships that have a functional purpose or impact within system 100, and/or one or more types of relationships that do not have a functional result.

The task scheduler component 110 may be configured to provide a schedule to a user. The schedule may include (1) tasks associated with a medical treatment regimen of the user and (2) indications of when individual ones of the tasks are to be performed by the user. The schedule may be based on input received from a healthcare provider. Examples of a healthcare provider may include one or more of a doctor, a nurse, a nurse practitioner, a physical therapist, a pharmacist, a family member, and/or other individuals that provide care. A given healthcare provider may be a professionally trained individual or an untrained individual. The schedule may be received from one or both of the user and/or a healthcare provider associated with the user. In some implementations, the user and/or a healthcare provider may access the schedule and provide revisions to the schedule. Such revisions may require approval by the user and/or a healthcare provider prior to being incorporated into the schedule, according to some implementations. The schedule may be prescribed by a healthcare provider. In some implementations, task scheduler component 110 may be configured to receive input from a healthcare provider and/or enable a healthcare provider to manipulate the schedule.

A given task may include an action associated with healthcare that is performed by the user. Examples of tasks may include one or more of taking a medication, performing a physical activity, monitoring weight, performing exercises, performing physical therapy such as for rehabilitation purposes, consuming a specific diet, using a medical device (e.g., medical device 119) correctly, performing other actions that help address a specific health condition, performing other actions that help address side effects from certain medications, taking a reading from a medical device that is integrated with a client computing platform 104 associated with the user, taking a reading from a medical device that is communicatively coupled with a client computing platform 104 associated with the user, having a reading from a medical device be in a specific range, and/or other tasks. By way of non-limiting example, a user may perform two separate tasks (or a single complex task) by taking a blood glucose reading and having the blood sugar in the proper range.

In some implementations, task scheduler component 110 may be configured to provide an alarm to the user to prompt the user to perform a given task. Such an alarm may include one or more of an audible sound, haptic feedback (e.g., a physical vibration), a visual indication, a pre-recorded message sent through a phone call to the user, and/or other alarms. In some implementations, such a pre-recorded message may include a voice message from a loved one of the user, a friend of the user, a healthcare provider, and/or other individuals.

The task scheduler component 110 may be configured to receive an indication from a user that one or more of the tasks have been performed or completed. In some implementations, the user may provide input via a client computing platform 104 to indicate a given task has been completed. For example, via a graphical user interface of a client computing platform 104, the user may check a box, click an icon, swipe an item, tap a portion of an image, and/or perform other methods for provided indications that individual tasks have been performed. In some implementations, an indication that one or more of the tasks have been performed or completed may be received automatically by task scheduler component 110. For example, a client computing platform 104 associated with the user and/or server 102 may be communicatively coupled to a medical device (e.g., medical device 119) and/or a therapeutic device (not depicted) configured to provide an indication that a task has been performed. Examples of a medical device and/or therapeutic device may include one or more of a heart monitor, a blood oxygen reader, a diabetic blood sugar reader, an activity tracker, a lung capacity reader (e.g., a spiroscope), and/or other medical devices and/or therapeutic devices. In some implementations, a client computing platform 104 associated with the user may be integrated as a singular device with one or more medical devices and/or therapeutic devices. In some implementations, task scheduler component 110 may be configured to provide an indication to a healthcare provider and/or other entity that one or more tasks have been performed by the user.

The content component 112 may be configured to provide emotionally positive units of content. A given unit may include one or more of a still image, a video, text (e.g., words used for motivation, humor, erotic poetry, and/or other text), and/or other content that can be observed by the user. A given unit of content may be designed to stimulate a dopamine response in the brain of the user when the first unit is observed by the user. In some implementations, a given unit of content may include explicit content portraying or suggesting sexual organs or sexual activity. A given unit of content may be erotic in nature. A given unit of content may be designed to stimulate erotic feelings. A given unit of content may be designed to stimulate aesthetic or emotional feelings.

The gamification component 114 may be configured to add a game aspect to system 100 such that the user must perform certain tasks before the user can observe content provided by content component 112. In some implementations, gamification component 114 may be configured to provide a given unit of content for presentation to the user via a client computing platform 104, wherein the given unit is initially presented as a concealed rendering of the given unit. The given unit may be associated with a given set of the tasks. In some implementations, the concealed rendering may depict the given unit as being obscured by an overlay or otherwise hidden. Such an overlay may be one or more of opaque, translucent, blurred, and/or formats that obscure underlying content. The gamification component 114 may be configured to progressively reveal the given unit by removing portions of the overlay. The removal of individual ones of the portions may be associated with performance of corresponding tasks. By way of non-limiting example, if the user takes a medication at a scheduled time, then a portion of the overlay may be removed to reveal an underlying portion of the given unit of content, in accordance with some implementations. The portions may be removed until the given unit of content is completely revealed responsive to the given set of the tasks being performed by the user. In some implementations, gamification component 114 may be configured to disallow portions from being removed before corresponding tasks are due to be performed, according to a schedule provided by task scheduler component 110.

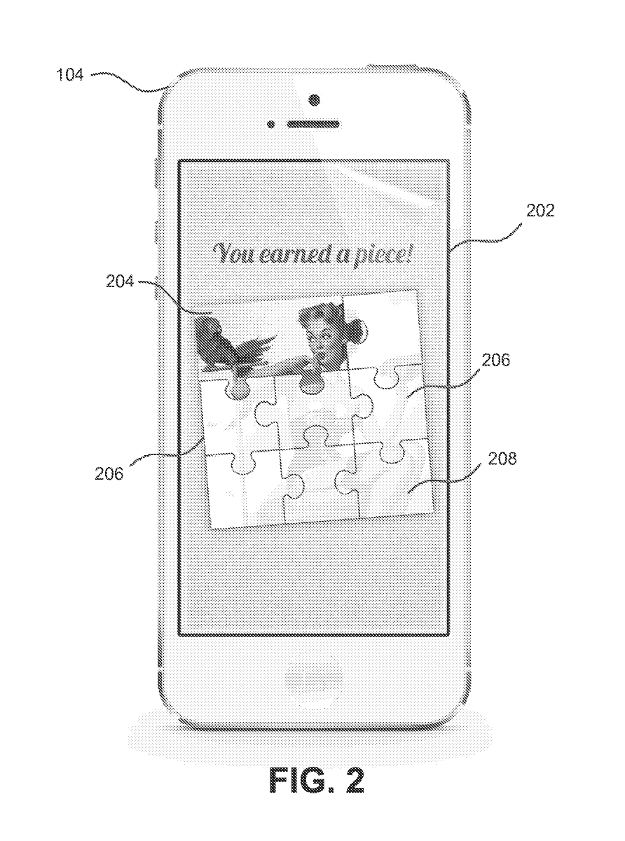

FIG. 2 illustrates an exemplary implementation of a unit of content that is partially revealed. In FIG. 2, an exemplary client computing platform 104 includes a display screen 202. The display screen 202 may be configured to present content to the user. As depicted in FIG. 2, display screen 202 includes a unit 204 of content that is partially concealed by an overlay 206. The overlay 206 may be divided into portions 208. A given portion 208 may be shaped as a puzzle piece, according to some implementations. The portions 208 may be shaped in any number of manners, in various implementations.

While exemplary implementations are described herein in the context of removing portions of an overlay to expose or reveal a unit of content, this is not intended to be limiting as other approaches for revealing units of content are contemplated by the disclosure. For example, in some implementations, a unit of content may be depicted as comprising an array of tiles, which are initially displayed with a blank side being viewable. Once a task is performed, a corresponding tile may be “flipped-over” to reveal a portion of content. As another example, a darkened content may “fade in” to visibility. In yet another example, blurred content may progressively become clearer. As still another example, no content may initially be presented and portions of content may be successively introduced and presented until the entire unit of content is viewable. In sum, the disclosure contemplates any technique for progressively presenting, revealing, and/or exposing a unit of content in which the unit is initially not viewable and progressively revealed until it is finally viewable.

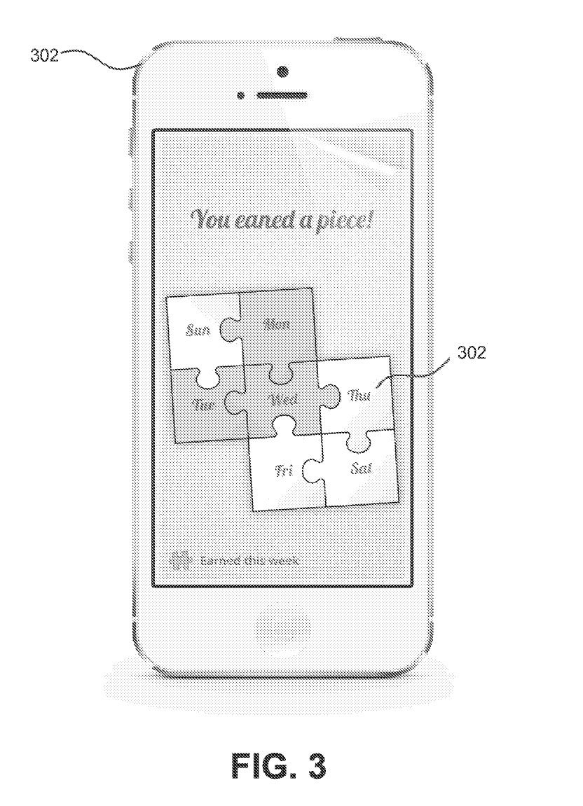

In some implementations, removed portions of the overlay may be a basis for a score or other tallied quantity. For example, the user may gain a certain number of points responsive to individual portions of a unit of content being revealed. One or more privileges may be granted to the user responsive to the score breaching a threshold. The one or more privileges may include gaining access to locked content, gaining an ability to play a game with another user, gaining an ability to communicate with another user, and/or other privileges. FIG. 3 illustrates an exemplary implementation in which the user earns puzzle pieces 302 for completing all tasks associated with individual days of the week. Once the puzzle is completed, the user may be entitled to a privilege.

Referring again to FIG. 1, socialization component 116 may be configured to facilitate interactions among users of system 100. Such interactions may include one or more of text communications, voice communications, video communications, and/or other types of communications. The interactions may be among user patients their healthcare providers. The interactions may be among patient users of the system. The interactions include games associated with completing scheduled tasks. In some implementations, removed portions may be used to provide a message to another user wherein individual removed portions correspond to individual letters or words. The user may be able to “follow” (e.g., akin to Twitter® followers), connect with (e.g., akin to Facebook® friends), and/or otherwise be associated with other users of the system. Such an association may be established responsive to a request from a first user to a second user. In some implementations, the second user may be required to approve the request.

In some implementations, socialization component 116 may facilitate a unit of content may be provided and/or created by other users of the system. Those other users may also be associated with the user (e.g., the other users may follow the user, the user may follow the other users, the user may be connected with the other users, and/or other associations). According to some implementations, socialization component 116 may provide for presentation to the user a list of other users of the system and their respective profiles. By way of non-limiting example, the user may be able to follow individual ones of those users by clicking a follow button on a given other user's profile. The user may upload a picture (e.g., a self-portrait), which may be included in the user's profile. The socialization component 116 may be configured to provide a notification to one or more other users associated with the user (e.g., followers, followees, connections, and/or other associated users). Such a notification may inform a given user that a hidden image (uploaded by the user) may be accessed and revealed, as described in connection with gamification component 114. The approach may allow the user to receive content that meets his/her specific needs or tastes. For example, the user may want to “follow” their favorite baseball player, celebrity, or other figure depending on their tastes.

The virtual currency component 118 may be configured to facilitate usage of virtual currency within system 100. In some implementations, removed portions of the overlay may be used as or equated to a virtual currency. Exposed units of content may be used as or equated to a virtual currency. An amount of virtual currency may be provided to a user responsive to a threshold number of portions being removed. Virtual currency may be redeemed for certain content (e.g., rare images, previously locked content, content provided by third-party entities, and/or other content), certain privileges (e.g., revealing an addition portion of a unit of content to accelerate the entire unit being revealed, and/or other privileges), and/or other items or information. By way of non-limiting illustration, a partner company such as a pharmaceutical company may want to ask the user questions about aspects of a drug taken by the user (e.g., any side effects experienced by the user, medical issues that the user is having, and/or other aspects of the drug). In order to reward the user for answering such questions, the partner company may provide to the user virtual currency, additional content, privileges within the system, and/or other information or items to motivate the user to answer the questions.

In some implementations, server(s) 102, client computing platform(s) 104, medical device 119, and/or external resources 122 may be operatively linked via one or more electronic communication links. For example, such electronic communication links may be established, at least in part, via a network such as a wired network or connection, a wireless network or connection (e.g., WiFi or Bluetooth), the Internet, and/or other networks. It will be appreciated that this is not intended to be limiting, and that the scope of this disclosure includes implementations in which server(s) 102, client computing platform(s) 104, medical device 119, and/or external resources 122 may be operatively linked via some other communication media.

A given client computing platform 104 may include one or more processors configured to execute computer program instructions. The computer program instructions may be configured to enable an expert or user associated with the given client computing platform 104 to interface with system 100 and/or external resources 120, and/or provide other functionality attributed herein to client computing platform(s) 104. By way of non-limiting example, the given client computing platform 104 may include one or more of a desktop computer, a laptop computer, a handheld computer, a tablet computing platform, a NetBook, a Smartphone, a gaming console, and/or other computing platforms.

External resources 120 may include sources of information, hosts and/or providers of content outside of system 100, external entities participating with system 100, medical devices, therapeutic devices, and/or other resources. In some implementations, some or all of the functionality attributed herein to external resources 120 may be provided by resources included in system 100.

Server(s) 102 may include electronic storage 122, one or more processors 124, and/or other components. Server(s) 102 may include communication lines, or ports to enable the exchange of information with a network and/or other computing platforms. Illustration of server(s) 102 in FIG. 1 is not intended to be limiting. Server(s) 102 may include a plurality of hardware, software, and/or firmware components operating together to provide the functionality attributed herein to server(s) 102. For example, server(s) 102 may be implemented by a cloud of computing platforms operating together as server(s) 102.

Electronic storage 122 may comprise non-transitory storage media that electronically stores information. The electronic storage media of electronic storage 122 may include one or both of system storage that is provided integrally (i.e., substantially non-removable) with server(s) 102 and/or removable storage that is removably connectable to server(s) 102 via, for example, a port (e.g., a USB port, a firewire port, etc.) or a drive (e.g., a disk drive, etc.). Electronic storage 122 may include one or more of optically readable storage media (e.g., optical disks, etc.), magnetically readable storage media (e.g., magnetic tape, magnetic hard drive, floppy drive, etc.), electrical charge-based storage media (e.g., EEPROM, RAM, etc.), solid-state storage media (e.g., flash drive, etc.), and/or other electronically readable storage media. Electronic storage 122 may include one or more virtual storage resources (e.g., cloud storage, a virtual private network, and/or other virtual storage resources). Electronic storage 122 may store software algorithms, information determined by processor(s) 124, information received from server(s) 102, information received from client computing platform(s) 104, and/or other information that enables server(s) 102 to function as described herein.

Processor(s) 124 may be configured to provide information processing capabilities in server(s) 102. As such, processor(s) 124 may include one or more of a digital processor, an analog processor, a digital circuit designed to process information, an analog circuit designed to process information, a state machine, and/or other mechanisms for electronically processing information. Although FIG. 1 shows processor(s) 124 as a single entity, this is for illustrative purposes only. In some implementations, processor(s) 124 may include a plurality of processing units. These processing units may be physically located within the same device, or processor(s) 124 may represent processing functionality of a plurality of devices operating in coordination. The processor(s) may be configured to execute computer program instruction components 106, 108, 110, 112, 114, 116, 118, and/or other components. Processor(s) 124 may be configured to execute components 106, 108, 110, 112, 114, 116, 118, and/or other components by software; hardware; firmware; some combination of software, hardware, and/or firmware; and/or other mechanisms for configuring processing capabilities on processor(s) 124. As used herein, the term “module” may refer to any component or set of components that perform the functionality attributed to the module. This may include one or more physical processors during execution of processor readable instructions, the processor readable instructions, circuitry, hardware, storage media, or any other components.

It should be appreciated that although components 106, 108, 110, 112, 114, 116, and 118 are illustrated in FIG. 1 as being implemented within a single processing unit, in implementations in which processor(s) 124 includes multiple processing units, one or more of components 106, 108, 110, 112, 114, 116, and/or 118 may be implemented remotely from the other modules. The description of the functionality provided by the different components 106, 108, 110, 112, 114, 116, and/or 118 described below is for illustrative purposes, and is not intended to be limiting, as any of components 106, 108, 110, 112, 114, 116, and/or 118 may provide more or less functionality than is described. For example, one or more of components 106, 108, 110, 112, 114, 116, and/or 118 may be eliminated, and some or all of its functionality may be provided by other ones of modules components 106, 108, 110, 112, 114, 116, and/or 118. As another example, processor(s) 124 may be configured to execute one or more additional computer program instruction components that may perform some or all of the functionality attributed below to one of components 106, 108, 110, 112, 114, 116, and/or 118.

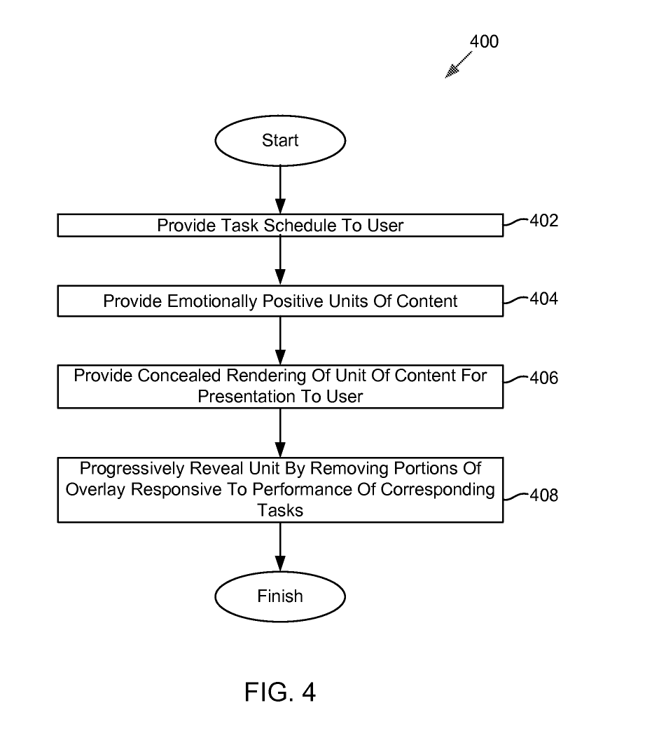

FIG. 4 illustrates a method 400 for providing emotionally positive content to motivate compliance with medical treatment regimens, in accordance with one or more implementations. The operations of method 400 presented below are intended to be illustrative. In some implementations, method 400 may be accomplished with one or more additional operations not described, and/or without one or more of the operations discussed. Additionally, the order in which the operations of method 400 are illustrated in FIG. 4 and described below is not intended to be limiting.

In some implementations, method 400 may be implemented in one or more processing devices (e.g., a digital processor, an analog processor, a digital circuit designed to process information, an analog circuit designed to process information, a state machine, and/or other mechanisms for electronically processing information). The one or more processing devices may include one or more devices executing some or all of the operations of method 400 in response to instructions stored electronically on an electronic storage medium. The one or more processing devices may include one or more devices configured through hardware, firmware, and/or software to be specifically designed for execution of one or more of the operations of method 400.

At an operation 402, a schedule may be provided to a user. The schedule may include (1) tasks associated with a medical treatment regimen of the user and (2) indications of when individual ones of the tasks are to be performed by the user. Operation 402 may be performed by one or more processors configured to execute a computer program instruction component that is the same as or similar to task scheduler component 110, in accordance with one or more implementations.

At an operation 404, emotionally positive units of content may be provided. The units of content may include a first unit. The first unit may include one or both of a still image or a video. The first unit may be designed to stimulate a dopamine response in the brain of the user when the first unit is observed by the user. Operation 404 may be performed by one or more processors configured to execute a computer program instruction component that is the same as or similar to content component 112, in accordance with one or more implementations.

At an operation 406, the first unit of content may be provided for presentation to the user. The first unit may be associated with a first set of the tasks. The first unit may be initially presented as a first concealed rendering of the first unit. The first concealed rendering may depict the first unit as being obscured by an overlay. Operation 406 may be performed by one or more processors configured to execute a computer program instruction component that is the same as or similar to gamification component 114, in accordance with one or more implementations.

At an operation 408, the first unit may be progressively revealed by removing portions of the overlay. The removal of individual ones of the portions may be associated with performance of corresponding tasks. The portions may be removed until the first unit of content is completely revealed responsive to the first set of the tasks being performed by the user. Operation 408 may be performed by one or more processors configured to execute a computer program instruction component that is the same as or similar to gamification component 114, in accordance with one or more implementations.

Although the present technology has been described in detail for the purpose of illustration based on what is currently considered to be the most practical and preferred implementations, it is to be understood that such detail is solely for that purpose and that the technology is not limited to the disclosed implementations, but, on the contrary, is intended to cover modifications and equivalent arrangements that are within the spirit and scope of the appended claims. For example, it is to be understood that the present technology contemplates that, to the extent possible, one or more features of any implementation can be combined with one or more features of any other implementation.

1. A system configured for providing emotionally positive content to motivate compliance with medical treatment regimens, the system comprising:
one or more processors configured to execute computer program instructions, the computer program instructions comprising:
a task scheduler component configured to provide a schedule to a user, the schedule including (1) tasks associated with a medical treatment regimen of the user and (2) indications of when individual ones of the tasks are to be performed by the user;
a content component configured to provide emotionally positive units of content including a first unit, the first unit including one or both of a still image or a video, the first unit being designed to stimulate a dopamine response in the brain of the user when the first unit is observed by the user; and
a gamification component configured to provide the first unit of content for presentation to the user, the first unit being associated with a first set of the tasks, the first unit initially being presented as a first concealed rendering of the first unit, the first concealed rendering depicting the first unit as being obscured by an overlay, the gamification component being further configured to progressively reveal the first unit by removing portions of the overlay, the removal of individual ones of the portions being associated with the performance of corresponding tasks, the portions being removed until the first unit of content is completely revealed responsive to the first set of the tasks being performed by the user.

2. The system of claim 1, wherein a given task includes one or both of taking a medication, performing a physical activity, using a medical device to take a reading or measurement, or having a reading form a medical device be in a specific range.

3. The system of claim 1, wherein the task scheduler component is further configured to provide an alarm to the user to prompt the user to perform a given task.

4. The system of claim 1, wherein the task scheduler component is further configured to receive an indication from a user that one or more of the tasks have been completed.

5. The system of claim 1, wherein the task scheduler component is further configured to provide an indication to a healthcare provider that one or more tasks have been performed by the user.

6. The system of claim 1, wherein the first unit of content includes explicit content portraying or suggesting sexual organs or sexual activity.

7. The system of claim 1, wherein the first unit of content is erotic in nature.

8. The system of claim 1, wherein the first unit of content is designed to stimulate erotic feelings.

9. The system of claim 1, wherein the first unit of content is designed to stimulate aesthetic or emotional feelings.

10. The system of claim 1, wherein the gamification component is further configured to disallow portions from being removed before corresponding tasks are due to be performed.

11. The system of claim 1, wherein the task scheduler component is further configured to disallow an indication from a user that a given task has been completed before the given task is due to be performed based on the schedule.

12. The system of claim 1, wherein the removed portions of the overlay are a basis for a score.

13. The system of claim 12, wherein one or more privileges are granted to the user responsive to the score breaching a threshold.

14. The system of claim 13, wherein the one or more privileges include gaining access to locked content, gaining an ability to play a game with another user, or gaining an ability to communicate with another user.

15. The system of claim 1, wherein the computer program instructions further comprise a socialization component configured to facilitate interactions among users of the system, the interactions being one or both of (1) among patients and their healthcare providers or (2) among patients, the interactions including one or more of text, voice, or video communication.

16. The system of claim 15, wherein the interactions include games associated with completing scheduled tasks.

17. The system of claim 1, wherein a given removed portion is used to provide a message to another user.

18. The system of claim 1, wherein the computer program instructions further comprise a virtual currency component configured to facilitate usage of virtual currency within the system.

19. The system of claim 1, wherein the task scheduler component is further configured to receive an indication that a given task has been performed by the user, the indication being received from one or more of the user, a medical device integrated as a singular device with a client computing platform associated with the user, or a medical device that is communicatively coupled with a client computing platform associated with the user.

20. A method for providing emotionally positive content to motivate compliance with medical treatment regimens, the method comprising:
executing computer program instructions using one or more processors to cause the one or more processors to:
provide a schedule to a user, the schedule including (1) tasks associated with a medical treatment regimen of the user and (2) indications of when individual ones of the tasks are to be performed by the user;
provide emotionally positive units of content including a first unit, the first unit including one or both of a still image or a video, the first unit being designed to stimulate a dopamine response in the brain of the user when the first unit is observed by the user; and
provide the first unit of content for presentation to the user, the first unit being associated with a first set of the tasks, the first unit initially being presented as a first concealed rendering of the first unit, the first concealed rendering depicting the first unit as being obscured by an overlay; and
progressively reveal the first unit by removing portions of the overlay, the removal of individual ones of the portions being associated with performance of corresponding tasks, the portions being removed until the first unit of content is completely revealed responsive to the first set of the tasks being performed by the user.
